(19) United States
(12) Patent Application Publication
(10) Pub. No.: US 2009/0241092 A1
(43) Pub. Date: Sep. 24, 2009

(54) Apparatus, methods, and computer program products providing improved application development for electronic devices

(75) Inventors: Ning-Nibble Yang, Beijing (CN); Jyri P. Salomaa, Espoo (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/079,191

(22) Filed: Mar. 24, 2008

(51) Int. Cl. G06F 9/46; G06F 9/44

(52) U.S. Cl. 717/115; 719/318

(57) ABSTRACT

Some exemplary embodiments of the invention provide enhancements such that, in accordance with a script, an electronic device/apparatus is capable of responding to a defined event by rendering a multimedia element (e.g., an image, a video clip, an audio clip) on the electronic device/apparatus. This further enhances the utility of the apparatus and enables it to operate in accordance with new functions, for example, by monitoring the user's blood pressure or blood sugar and providing announcements according (e.g., when a user's measured blood sugar exceeds a specified value). In one non-limiting exemplary embodiment, a method includes: subscribing to at least one event defined in a script, wherein at least one multimedia element is defined in the script; and rendering, in response to receiving a notification when the at least one event occurs at an apparatus, the at least one multimedia element in the apparatus.

### TECHNICAL FIELD

The exemplary embodiments of this invention relate generally to application development for electronic devices. In particular, the exemplary embodiments of this invention relate to developing applications using scripting languages.

### BACKGROUND

Scripting languages or scripts are programming languages that are typically interpreted and can be typed directly from a text editor. Scripts are often distinguished from programs that are converted permanently into binary executable files before they are run. Scripts generally remain in their original form and are interpreted command-by-command each time they are run. Scripts can also be compiled, but because interpreters are simpler to write than compilers, they are generally interpreted more often than they are compiled. Typical scripting languages include HyperText Markup Language (HTML), Extensible Markup Language (XML), Standard Generalized Markup Language (SGML), Extensible HyperText Markup Language (XHTML), Synchronized Multimedia Integration Language (SMIL), UNIX/Linux shell scripts and Javascripts. These scripting languages can be run on an electronic device such as a mobile phone, a Personal Digital Assistant (PDA), an integrated messaging device, or a laptop computer.

Synchronized Multimedia Integration Language (SMIL) is one type of scripting language recommended by the World Wide Web Consortium (W3C) for describing multimedia presentations. It defines markup for timing, layout, animations, visual transitions and media embedding. SMIL 2.0 became a W3C Recommendation in August 2001. Other standard bodies, such as 3rd Generation Partnership Project (3GPP), also adopted SMIL standard (3GPP SMIL). One example of an application based on SMIL is Multimedia Messaging Service (MMS) and thus every MMS viewer is a MMS SMIL (a subset of 3GPP SMIL) player.

Generally, it is difficult to enhance existing applications or develop new applications for electronic devices, that is, most electronic device applications are functionally restricted. For example, the alarm management application 110 of a typical mobile device (as shown in FIG. 1) can support only one reminder at a time. If users want to set three reminders they have to look for other applications. Moreover, most manufacturer built-in applications like Phonebook or Messaging are not open source for third parties to create own extensions. For example, almost no mobile device today supports changing Short Message Service (SMS) notification's visual effect to something other than the default small envelop indicator. Another example is most mobile device players for continuous media (like music and video) do not support “seeking” or “speed control” functionality.

### SUMMARY

In accordance with an exemplary embodiment of this invention, there is provided a method comprising: subscribing to at least one event defined in a script, wherein at least one multimedia element is defined in the script; and rendering, in response to receiving a notification when the at least one event occurs at an apparatus, the at least one multimedia element in the apparatus.

Further in accordance with an exemplary embodiment of this invention, there is provided an apparatus comprising: at least one user interface component; and a processor configured to subscribe to at least one event defined in a script, wherein at least one multimedia element is defined in the script, wherein the processor is further configured, in response to receiving a notification when the at least one event occurs at the apparatus, to render the at least one multimedia element in the apparatus using the at least one user interface component.

Further in accordance with an exemplary embodiment of this invention, there is provided a program storage device readable by an apparatus, tangibly embodying a program of instructions executable by the machine for performing operations, said operations comprising: subscribing to at least one event defined in a script, wherein at least one multimedia element is defined in the script; and rendering, in response to receiving a notification when the at least one event occurs at the apparatus, the at least one multimedia element in the apparatus.

### BRIEF DESCRIPTION OF THE DRAWINGS

These and other advantages and features of the invention, together with the organization and manner of operation thereof, will become apparent from the following detailed description when taken in conjunction with the accompanying drawings, wherein like elements have like numerals throughout the several drawings described below.

FIG. 1 shows an interface for an alarm management application of a typical mobile device.

FIG. 2 shows an exemplary block diagram illustrating a portion of the potential software structure for an exemplary embodiment of the invention.

FIG. 3 illustrates an example of a cross device progress bar using the “barWipe” transition effect in accordance with an exemplary embodiment of the invention.

FIG. 4 depicts an example of a cross device progress indicator using a character moving from one device to the other device (via formimg files).

FIG. 5 illustrates a simplified block diagram of an exemplary electronic device that is suitable for use in practicing the exemplary embodiments of this invention.

FIG. 6 depicts additional components and connections for the exemplary electronic device of FIG. 5.

FIG. 7 depicts a flowchart illustrating one non-limiting example of a method for practicing the exemplary embodiments of this invention.

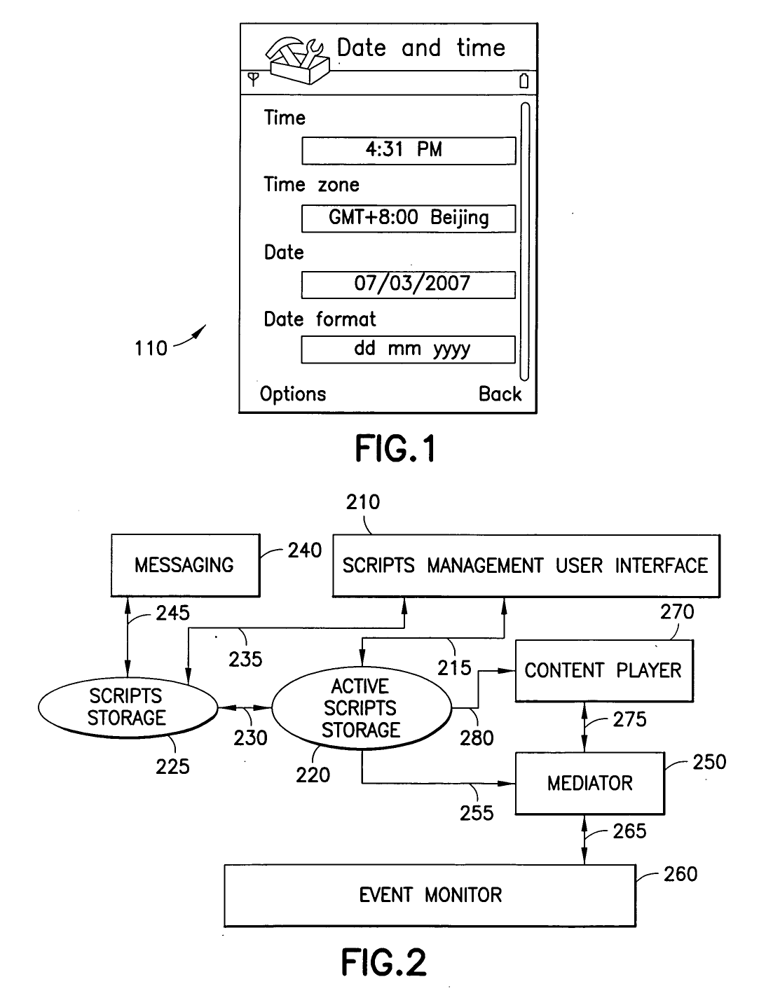

### DETAILED DESCRIPTION

It would be desirable to provide a new method that can be used to enhance existing applications or develop new applications for electronic devices. Various exemplary embodiments of this invention describe methods, devices and computer programs for enhancing existing applications and developing new applications.

In one, non-limiting exemplary embodiment, scripts (e.g., SMIL scripts) are enhanced such that they are capable of responding to events occurring at or in relation to an electronic device, such as a mobile terminal or mobile phone. For example, an SMIL engine of the electronic device can be configured to execute enhanced SMIL scripts, for example, in order to improve a user's experience with the device. In further exemplary embodiments, the enhanced SMIL scripts enable a user or a third party to specify one or more actions that are triggered by one or more events or conditions occurring.

SMIL provides a logical timing framework in which the structured relationship of objects is used to define most timing relationships among objects. By introducing event-based activation or termination, exemplary embodiments of the invention let users define a dynamic activation path using SMIL. Conventional SMIL standards and recommendations are ill-suited for purposes of the exemplary embodiments of the invention since the begin and active end times of SMIL elements support limited declarative, interactive timing. Interactive in this sense may include user events (e.g., mouse clicks), events raised by media players like a PlayComplete event (locally), and events raised by the presentation engine itself, such as a pause event. While SMIL recommendations may emphasize that the SMIL timing model references user events, the model does not define how these events are generated, and in particular does not define semantics of keyboard focus, mouse containment, “clickability”, and related issues. Thus, phone events are not precluded and may be included in SMIL documents in a similar manner.

A MMS application may connect some phone events with SMIL content playing using its SMIL engine, for example, the key press event to open a MMS (after which the SMIL content (message body) is playing) or the outgoing call event (after users activate the link to a phone number contained in the message). However, except for the “messaging constrains content playing” issue, the MMS application is a manufacturer built-in application by itself, so it is difficult to add more event support.

Symbian S60 phones use an open script language (Python for S60) enabling users to develop new applications. However, this still requires programming skills and is very different from SMIL since SMIL is a content-based solution. Furthermore, the event connection with Python scripts is still weak as, unless an extension module is provided by the symbian programmers (such a module is generally difficult to write), few events other than keyPress can be currently observed.

In another non-limiting, exemplary embodiment, instead of modifying built-in applications or developing a new application for various scenarios (see examples below), a SMIL engine is used which is able to detect phone events and activate or terminate any corresponding elements in a SMIL document. Additionally, similar to the S60's efforts in adding phone-call making to MMS SMIL link semantic, phone-outgoing events, such as short message sending (and also sending of the script itself), can be generated in SMIL link semantic (see examples below). Thus, the enhanced SMIL scripts implemented by the exemplary SMIL engine provide additional capabilities (e.g., multimedia capabilities) beyond those available with conventional scripts and conventional SMIL scripts.

FIG. 2 shows a block diagram of one possible implementation of an exemplary embodiment of the invention. As depicted in FIG. 2, a user can perform script management functions through a Scripts Management User Interface 210, which allows the user to perform activities such as to create, edit, delete, replace, download, activate or deactivate scripts. The Scripts Management User Interface 210 can include a simple text editor, with or without support of pre-defined scripts or templates (e.g., the electronic device manufacture and/or the mobile service operator can provide pre-defined scripts or templates). The Scripts Management User Interface 210 can also include the capability for downloading scripts from a network or via the Internet.

The Scripts Management User Interface 210 can also include a user interface which allows the user to activate or deactivate scripts, as indicated by connection 215. The activated scripts can be saved at an Active Scripts Storage 220, which can be implemented as a separate storage from a Scripts Storage 225. If the Active Scripts Storage 220 is implemented as a separate storage, scripts can be copied or moved from the Scripts Storage 225 to the Active Scripts Storage 220 when the user decides to activate one or more scripts, as shown by connection 215. If the user decides to deactivate one or more scripts, the corresponding scripts in the Active Scripts Storage 220 can be either removed from the Active Scripts Storage 220 or moved back to the Scripts Storage 225. If the Active Scripts Storage 220 is implemented as a separate storage, the user can perform activities such as create, edit, delete, replace, and download (e.g., as indicated by connection 235) in Scripts Storage 225. After one or more scripts have been updated in the Scripts Storage 225, for example, as a result of the user's editing or downloading of an updated version, and if the updated one or more scripts are activate scripts, the updated one or more scripts need to be copied or moved from the Scripts Storage 225 to the Active Scripts Storage 220 after the updates. The user can also perform activities such as create, edit, delete, replace, and download directly on scripts in the Active Scripts Storage 220, however it may be desirable to have such activities coordinated with a Mediator 250 and a Content Player 270.

Alternatively, the Active Scripts Storage 220 can share the same storage as the Script Storage 225. One possible, exemplary implementation is to have each script in the Scripts Storage be associated with an indicator (for example, one bit to represent true or false) to indicate whether the script is activated. The value of the indicators of the corresponding one or more scripts can be changed to true when the user decides to activate the one or more scripts. If later the user decides to deactivate one or more scripts, the value of the indicators of the corresponding one or more scripts can be changed back to false.

As shown in FIG. 2, Messaging 240 can also be used to perform activities such as sending a script. A message which contains a script can be delivered to the electronic device through services such as email or Messaging Service (MMS/SMS). As indicated by connection 245, the user can either manually move the scripts to the Scripts Storage 225 or the electronic device can automatically move the scripts to the Scripts Storage 225 based on some pre-defined criteria. Similarly, the user can send scripts to another user or distribute scripts to a group of other users through the Messaging 240. This is one way a user can achieve the goal of playing a script (created by this user) on another user's device in response to one or more events on that user's device. For example, a user can create a script which will display a happy birthday card and play a happy birthday song at a specified time. The user can send the script through email or MMS/SMS to his/her friend who may not be in the same time zone as the user. It is therefore possible for the user to play the script at the time of his/her friend's birthday on his/her friend's device.

As shown in FIG. 2, a Mediator 250 gets active scripts from the Active Scripts Storage 220 (e.g., as indicated by connection 255). The Mediator 250 also subscribes to event notification from an Event Monitor 260 according to the active scripts. The Event Monitor 260 notifies the Mediator 250 when the event occurs, as indicated by connection 265. The Content Player 270 may also get active scripts from the Active Scripts Storage 220, as indicated by connection 280. If the Content Player 270 gets active scripts from the Active Scripts Storage 220, interpretation of the one or more active scripts can be started even before the event triggers (e.g., event requirements) in the scripts actually occur. In this case, when the Content Player 270 interprets one or more scripts from the Active Scripts Storage 220, the event requirement in the scripts can be temporarily marked “unresolved”. When the Event Monitor 260 notifies the Mediator 250 at the time the event occurs, the Mediator 250 can forward the notification from the Event Monitor 260 to the Content Player 270, as indicated by connection 275. The Content Player 270 can then resolve the event and start rendering the corresponding content such as audio or video clips, for example. Alternatively, the Mediator 250 can analyze event relationships, match event parameters, create scripts and feed the scripts to the Content Player 270, as indicated by connection 275. In this case, the Content Player 270 may only be responsible for rendering the content. Although the Content Player 270 and the Mediator 250 in FIG. 2 are depicted as two separate entities, a person of ordinary skill in the art will understand that it is possible to implement the functionality of the Content Player 270 and the Mediator 250 as a single entity (e.g., a single program, function or collection of functions).

The exemplary embodiments of the invention can be used to enhance existing applications or define new applications for electronic devices. In describing examples below, SMIL scripts are used as non-limiting examples. Persons with ordinary skill in the art will understand that other scripting languages can also be used to define the new application. The descriptions below are only intended as examples of existing applications that can be enhanced or as new applications that can be defined by a scripting language, and is not intended to limit the scope of this patent application.

One example of an application that can be created according to the exemplary embodiments of this invention is a pill-taking reminder (e.g., each reminder plays for 20 seconds or is stopped by a click on a button or icon on the screen of the electronic device). The following SMIL script is an example that shows a “prompt for taking pills” animated picture and plays a reminder voice three times every day. By using the script below, a user can also set his relative's pill-taking reminder through services such as email or Messaging Service (MMS/SMS), for example.

```
<smil xmlns=“http://www.w3.org/2001/SMIL20/Language”>
...
<body>
  <excl begin=“phoneAlarm(time=“08:00:00”)” dur=“indefinite”>
    <par>
      < img id=“image1” src=“take_morning_pills.gif”
      dur=“20s” end=“click”/>
      <audio id=“voice_morning” src=“morning_reminder.amr”
begin=“image1.begin”/>
    </par>
    <par>
      < img id=“image2” src=“take_noon_pills.gif” begin=“5:30:00”
dur=“20s” end=“click”/>
      <audio id=“voice_noon” src=“noon_reminder.amr”
      begin=“image2.begin”/>
    </par>
    <par>
      < img id=“image3” src=“take_night_pills.gif” begin=“14:05:00”
dur=“20s” end=“click”/>
      <audio id=“voice_night” src=“night_reminder.amr”
      begin=“image3.begin”/>
    </par>
  </excl >
</body>
</smil>
```

Another example of an application that can be created according to the exemplary embodiments of this invention is a virtual diary (for example, for pictures taken by a camera on the electronic device). By connecting calendar events with content playing, a “virtual diary” application is created through which user-generated content, such as pictures or videos taken on that day can be played when browsing the calendar and moving the cursor to a certain date. In this example, it is possible to have an automatic script generator produce scripts such as the one below by analyzing the picture data so the user does not need to manually create the scripts.

```
<smil xmlns=“http://www.w3.org/2001/SMIL20/Language”>
...
<body>
  <excl>
    ...
    <img id=“image20061013125” src=“20061013125.jpg”
      begin=“calenderEvent(date=“20061013”)” dur=“5s” end=“click”/>
    <img id=“image20061013126” src=“20061013126.jpg” dur=“5s”
    end=“click”/>
    <img id=“image20061014134” src=“20061014134.jpg”
        begin=“calenderEvent(date=“20061014”)” dur=“5s”
        end=“click”/>
    ...
  <excl/>
</body>
</smil>
```

Another example of an application that can be created according to the exemplary embodiments of this invention is a screen saver. By running the following script, a screen saver can be created to show a slide of one or more pictures along with one or more pieces of music:

```
<smil xmlns=“http://www.w3.org/2001/SMIL20/Language”>
...
<body>
  <par begin=“inactivityEvent” end=“activityEvent”>
    <seq repeatDur=“indefinite”>
    ...
      <img src=“Jackie_pic1.jpg” dur=“2s”/>
      <img src=“Jackie_pic5.jpg” dur=“2s”/>
    ...
    <seq/>
    <audio src=“Jackie_love.mp3” repeatDur=“indefinite” />
  <par/>
</body>
</smil>
```

Another example of an application that can be created according to the exemplary embodiments of this invention is a Kuso effect (change the overdub of a film clip to another voice) screensaver. Continuing with the screensaver example discussed above, Kuso can be used as a screensaver, generated by SMIL script as follows:

```
<smil xmlns=“http://www.w3.org/2001/SMIL20/Language”>
<head>
  <layout>
        <region id=“Video” soundLevel=“1%”/>
  </layout>
</head>
...
<body>
  <par>
    <video id=“film_clip” src=“clip_of_Titanic.rm” region=“Video” />
    <audio id=“my_voice” src=“recorded_voice.amr” />
  </par>
</body>
</smil>
```

Another example of an application that can be created according to the exemplary embodiments of this invention is a location-based reminder. The following script uses location positioning devices and systems, such as the Global Positioning System (GPS), to create a location-based reminder application. Here, when the user arrives at a specified shopping center, the user will get a reminder to buy a T-shirt. The location of this shopping centre is based on its GPS information (e.g., a 100 meter range around the point 39.1111:113.1313). One could also use the cell-id of the electronic device to obtain an approximate location of the user.

```
<smil xmlns=“http://www.w3.org/2001/SMIL20/Language”>
...
<body>
  <par>
    <img id=“img1” src=“buy_T_shirt.gif”
begin=“GPSEvent(centre=“39.1111:113.1313”,range=“100.0m”)”
                dur=“20s” end=“click”/>
    <audio id=“note_from_wife” src=“voice_note.amr”
    begin=“ img1.begin” />
  <par/>
</body>
</smil>
```

Another example of an application that can be created according to the exemplary embodiments of this invention is a blood pressure alert system. Assume the user's mobile device is equipped with a blood pressure probe accessory. By running the following script, when the probe determined that the user's blood pressure is out of a normal range, an alerting picture is shown in the Image1 region, and a short message containing this information is automatically sent to the user's private doctor or relatives as the receiver number indicates. If the user's mobile device is equipped with another accessory, such as a blood sugar monitor, similar applications can be defined for people with diabetes.

```
<smil xmlns=“http://www.w3.org/2001/SMIL20/Language”>
<head>
  <layout>
    <root-layout width=“320” height=“120”/>
    <region id=“Image1” left=“10%” height=“50%” />
  </layout>
</head>
<body>
  <par>
    <img id=“alert” src=“blood_pressure_alert.gif”
          begin=“blood_pressure_probe_alert(file:
          blood_pressure_threshold.xml)”
          region=“Image1” dur=“20s”/>
    <par begin=“alert.begin+20s”>
      <a href=“sms:+358501234567(blood_pressure.xml)”
      actuate=“onLoad”>
      </a>
    </par>
  </par>
</body>
</smil>
```

Another example of an application that can be created according to the exemplary embodiments of this invention is a birthday card. Suppose user A and user B are friends. User B has a birthday coming up next weekend but user B will be traveling to meet her parents and cannot meet her friends. On Friday when user A meets User B before she leaves for her hometown, user A gives her a present and a script similar to the pill-taking reminder application discussed above. On user B's birthday, her mobile device starts to blink. There is a surprise from user A: an animation with a Happy Birthday song. In other exemplary embodiments, the content to be played might be something user A created with great emotion, for example, a so-called “electric letter” with user A's own handwriting and/or voice, in a similar way as in the Kuso effect example discussed above.

Another example of an application that can be created according to the exemplary embodiments of this invention is a photo-based phonebook. For disabled or illiterate people, images, cartoons or other visual effects are preferred to a text-based user interface, such as the interface to input short messaging characters or search in a phonebook. The below script example shows a photo-based phonebook simply using the phone-call making link attribute supported, in which people can browse a list of photos and make a phone call by selecting a photo.

```
<smil xmlns=“http://www.w3.org/2001/SMIL20/Language”>
...
<body>
  <excl>
    <a href=“phoneto:+358501234567”>
      <img id=“image1” src=“son.jpg” begin=“0s” dur=“5s”/>
    </a>
    <a href=“phoneto:+3585087654321”>
      <img id=“image2” src=“doctor.jpg”
        begin=“5s; image1.keyPress(code=“next”)” dur=“5s”/>
    </a>
    <a href=“phoneto:+3585054321678”>
      <img id=“image3” src=“neighbor.jpg”
          begin=“10s; image2.keyPress(code=“next”)” dur=“5s”/>
    </a>
    ...
  </excl>
</body>
</smil>
```

Another example of an application that can be created according to the exemplary embodiments of this invention is one that uses multimedia to provide incoming caller information (“multimedia incoming caller information”). By running the example script below, when receiving a call from John, his portrait, job, and device used (e.g., home, work or mobile) are shown on the screen in parallel with a particular ringing-tone played with a 15 second offset:

```
<smil xmlns=“http://www.w3.org/2001/SMIL20/Language”>
<head>
  <layout>
    <root-layout width=“320” height=“120”/>
    <region id=“Portrait” left=“10%” height=“70%” />
    <region id=“Job” left=“10%” top=“70%” height=“10%” />
    <region id=“Device_type” left=“10%” top=“80%” height=“10%” />
    <region id=“Name” left=“10%” top=“90%” height=“10%” />
  </layout>
</head>
<body>
  <par begin=“inComingCallRecv(number=“+3585054321678”)”>
    <img id=“from_john” src=“portrait.gif” region=“Portrait”/>
    <text id=“job” src=“job_of_john.txt” region=“Job” />
    <text id=“device_type” src=“device_used.txt”
    region=“Device_type” />
    <text id=“name” src=“name.txt” region=“ Name” />
    <audio id=“ringing_tone_for_john” src=“voice_of_john.mp3”
      begin=“ from_john.begin-15s” higher=“pause”/>
  </par>
</body>
</smil>
```

In the example SMIL script above, “voice_of_john.mp3” is an example of a ring tone in MPEG Audio Layer 3 (mp3) format. One of ordinary skill in the art will understand that other formats for ring tones can also be used. Also in the example SMIL script above, the “higher=“pause”” portion means the default ringing tone for all in-coming calls could pause the play of voice_of_john.mp3 according to the SMIL priority class element semantic. Instead, if the SMIL script example had “peers=“defer””, then all ringing tones together would be considered as peers, and the system default one is deferred if voice_of_john.mp3 is being played. Possible implementation for this semantic is to utilize the mobile device observed “media play ready” and “complete” events. Also notice that SMIL natively specifies “seeking” or “speed control” for continuous media playing exemplified here by playing voice_of_john.mp3 from a certain offset.

Another example of an application that can be created according to the exemplary embodiments of this invention is a multimedia incoming short message notification, which is similar to the “multimedia incoming caller information” described above. By changing the event to a short message receiving event, when receiving a short message from John, an animated GIF file (e.g., wallowing_piggy.gif) in parallel with an mp3 file (e.g., Jackie.mp3) is played. The “higher” semantic here is for the default short message prompt.

```
<smil xmlns=“http://www.w3.org/2001/SMIL20/Language”>
...
<body>
  <par>
    <img id=“from_john” src=“wallowing_piggy.gif”
      begin=“smsRecv(sender=“john”)” />
    <audio id=“rock” src=“Jackie.mp3” begin=“from_john.begin”
    higher=“pause”/>
  </par>
</body>
</smil>
```

In general, this example can be extended to show different visual/audio effects for different short message senders or even based on the message text (e.g., to provide an alert for ajunk message).

Another example of an application that can be created according to the exemplary embodiments of this invention is a safe distance alert. By messaging scripts such as the one in the location-based reminder example discussed above, parents can have their child's mobile device play an alert or send a message when the child is going too far from one or more certain locations. This is an example in which mobile device communication related events can be used in creating the application. During one-directional data flow like messaging, handshaking events can be bi-directional. These bi-directional events can be used for at least two purposes. First, they can be used to notify the sender that the communication has happened. For example, in the above monitoring system, the sender is informed that the communication happens successfully as “safe place” alerting is sent to the parents. Second, such events can make all participants show a certain effect at the same time, which means the timeline is also expanded to another mobile device through communication. The “cross-device progressing bar” application, described in the below paragraph, shows two scripts for a Bluetooth connection imitator and receiver, individually, to show the effect of a cross-device progressing bar (e.g., for use when transferring a list of files over the connection).

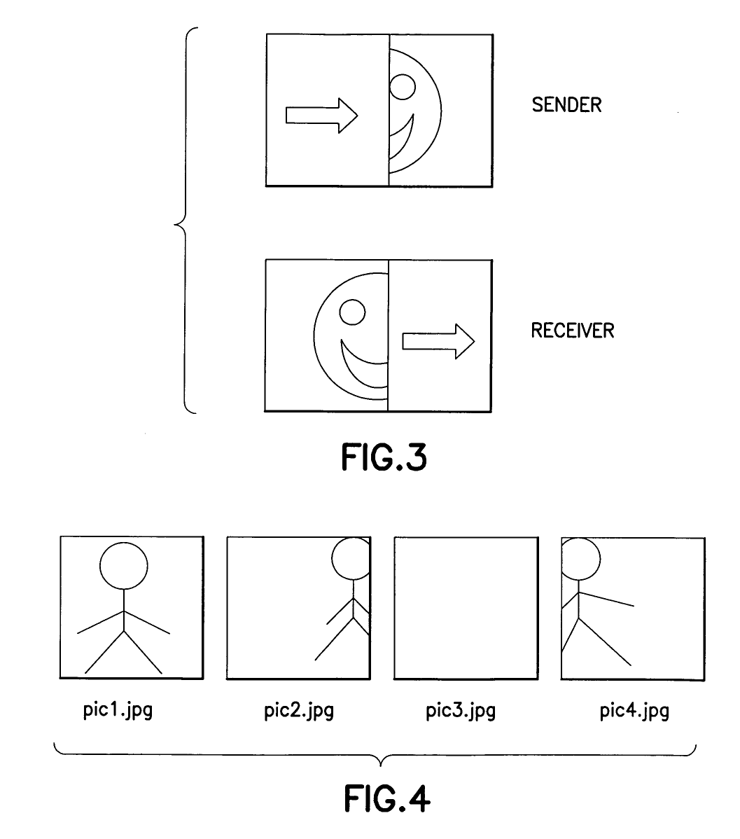

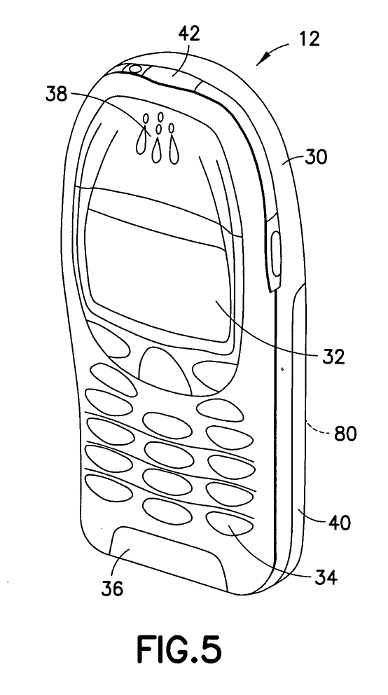

Another example of an application that can be created according to the exemplary embodiments of this invention is a cross device progress bar. A connection imitator and receiver have their mobile devices show the effect of a cross device progress bar, for example, when transferring a list of files over a connection such as Bluetooth. Two exemplary solutions are provided here. The first uses the “barWipe” transition effect to wipe off the picture shown on the sender and show it on the receiver's device to give the feeling of something being moved to the receiver, as shown in FIG. 3. The second solution is to simulate this effect using content, showing one character moving from one device to the other (picl-pic4, as shown in FIG. 4). The effect in solution 2 can be further improved through creating a series of more accurate pictures, such as cartoons, or based on one integrated animated image file. In this case, one would show the frames using the SMIL clipBegin semantic instead of showing individual image files. Here the receiver's script can be messaged to the mobile device during connection built-up process. Below are shown example scripts for the two solutions.

Solution 1: using barwipe transition effect

Sender's script:

```
<smil xmlns=“http://www.w3.org/2001/SMIL20/Language”>
<head>
  <transition id=“tr_bar” type=“barWipe” subtype=“leftToRight”
  dur=“3s” />
</head>
<body>
  <seq begin=“BT_transfer_started” end=“BT_transfer_finished”
repeatDur=“indefinite”>
    <img src=“SmileyFace.jpg” dur=“3s” transOut=“tr_bar”/>
  </seq>
  </body>
</smil>
```

Receiver's script:

```
<smil xmlns=“http://www.w3.org/2001/SMIL20/Language”>
<head>
  <transition id=“tr_bar” type=“barWipe” subtype=“leftToRight”
  dur=“3s” />
</head>
<body>
  <seq begin=“BT_transfer_started” end=“BT_transfer_finished”
repeatDur=“indefinite”>
    <img src=“SmileyFace.jpg” dur=“3s” transIn=“tr_bar”/>
  </seq>
  </body>
</smil>
```

Solution 2: using user created animated effect:

Sender's script:

```
<smil xmlns=“http://www.w3.org/2001/SMIL20/Language”>
...
<transition id=“wipe1” type=“barWipe” subtype=“leftToRight”
dur=“0.1s”/>
...
<body>
  <seq begin=“BT_transfer_started” end=“BT_transfer_finished”
repeatDur=“indefinite”>
    <img src=“pic1.jpg” dur=“0.5s” fill=“transition”/>
    <img src=“pic2.jpg” dur=“0.5s” fill=“transition” transIn=“wipe1”/>
    <img src=“pic3.jpg” dur=“0.5s” fill=“transition” transIn=“wipe1”/>
  </seq>
  </body>
</smil>
```

Receiver's script:

```
<smil xmlns=“http://www.w3.org/2001/SMIL20/Language”>
...
<body>
  <seq begin=“BT_transfer_started” end=“BT_transfer_finished”
repeatDur=“indefinite”>
    <img src=“pic3.jpg” dur=“0.5s” fill=“transition”/>
    <img src=“pic4.jpg” dur=“0.5s” fill=“transition” transIn=“wipe1”/>
    <img src=“pic1.jpg” dur=“0.5s” fill=“transition” transIn=“wipe1”/>
  </seq>
  </body>
</smil>
```

Another example of an application that can be created according to the exemplary embodiments of this invention is an online multimedia health care system. As described in the exemplary blood pressure reminder application above, when the blood pressure or blood sugar is out of range, a short message is sent to a server. The server's script (i.e., the service) then reacts to this event by, for example, messaging a SMIL script to a certain doctor. That doctor could then have a visual/audio prompt. Through the interaction embedded in the script (for example, voice selection when the doctor's hands are occupied in operations) about how to handle this issue, the doctor's advice is sent to the server. Based on this short message or script, the server messages another SMIL script back to the patient with the doctor's instructions, such as what pills to take or what to measure next. This can be shown using multimedia capabilities (for example, the pill bottle picture may be easier for the patient to recognize in a bad situation). If more measurements are needed, for example measurements of heart rate or blood sugar, after the measurement, the result may be sent to the server and communication can continue similar to that described above.

Another example of an application that can be created according to the exemplary embodiments of this invention is a reminder that reminds the user, for example, after two or more events have happened. Assume here two events, “after Christmas party (might be any day in December, for example Dec. 18 (12/18))”, and “after 8 o'clock”, should both occur before a reminder is triggered, for example, to send a present to Linda. The script is similar to the pill-taking reminder discussed above, but a new event relationship specification “event-seq” should be introduced as follows:

<excl begin=“ event-seq: phoneAlarm(date=“12/18”),
phoneAlarm(time=“08:00:00”)” ...>

In this example, event relationships are constructed in two ways. One way is to construct such relationships from SMIL semantics. The following two SMIL document samples show the relationship of playing content “after receiving events a, b, and c in sequence” (using the <seq> element) and “after all events a, b, and c occur but in any sequence” (using the customTest element since a group of custom attribute testing is of the “and” relationship).

Relationship 1—playing content “after receiving event a, b, and c in sequence”:

```
<seq id=“a” begin=“event_a”>
  <seq id=“b” begin=“event_b”>
    <seq id=“c” begin=“event_c”>
      ...content to play here
```

Relationship 2—playing content “after all events a, b, and c occur but in any sequence”:

<audio id=“piano” src=“piano.mp3”
customTest=“var_event_a + var_event_b + var_event_c” />

Another way is to make use of the event parameter. In SMIL specification, very limited event parameters are supported, such as the number of times to be repeated and mediaParam. Fortunately, the SMIL engine is an XML parser itself so by nature the SMIL document is extensible with augmented events that can be expressed as XML data, like the “file:” portion in the blood pressure alert system described earlier. Thus, the document to play can have its event parameter (for example, as a regular expression specification) matched based on values of designated tags such as “sender” in the multimedia incoming short message application described above. This XML format event parameter may require the event observer to perform some conversion. However, it provides a more general and extensible solution to many problems (like the above “and” relationship) by generating a new event (or by calling a DOM method) after all events set a corresponding Boolean variable in an intermediate XML document (in the similar semantic of the “uid” attribute of the “customAttributes” element).

Another example of an application that can be created according to the exemplary embodiments of this invention is to play a vibrating guitar when playing Rock music. A connection of a music type and an image are used here to extend the previous connection between a concrete music clip and an image. For example, when playing a music clip of “Rock” type, show the animated gif of a vibrating guitar. Two solutions are provided here. The first uses SMIL's “metadata” and “content control” semantics by enabling the image element only when the metadata of the music is of the right value. Note that SMIL “metadata” and “customTest” elements give SMIL script the capability to include “type” and “variable” concepts. The second solution is, if it is possible to describe the relationship using an event parameter, one can make use of the event parameter. This is one example how an event processing entity, such as the Mediator 250 in FIG. 2, can process metadata information about SMIL scripts. Exemplary scripts for these two solutions are presented below.

Solution 1: solely using SMIL's “metadata” and “content control” semantics:

Music's SMIL with metadata:

```
<smil xmlns=“http://www.w3.org/2001/SMIL20/Language”>
<head>
  ...
  <metadata>
    <rdf:RDF
        ...
        xmlns:dc = http://purl.org/metadata/dublin_core#>
      <rdf:Description about=“ http://www.example.com/music/
      Jack_1.mp3”
          dc:Type=“Rock”>
      </rdf:Description>
    </rdf:RDF>
  </metadata>
</head>
<body>
  ...
  <audio src=“/music/Jack_1.mp3” />
</body>
</smil>
```

SMIL script contains connection of “music type” and “image to play”:

```
<smil xmlns=“http://www.w3.org/2001/SMIL20/Language”>
...
<body>
  ...
  <img id=“rock_img” src=“vibrating_guitar.gif”
  customTest=“type_of_Rock” />
</body>
</smil>
```

Solution 2: using event parameter:

```
<smil xmlns=“http://www.w3.org/2001/SMIL20/Language”>
...
<body>
  ...
  <img id=“rock_img” src=“vibrating_guitar.gif”
      begin=“audioOpenComplete(type=“Rock”)” />
</body>
</smil>
```

Another example of an application that can be created according to the exemplary embodiments of this invention is to share music after matching play lists. For example, user A has one collection of Jackie's songs while user B has another collection. User A asks his device to find the songs he is still missing by connecting his device to User B's device. After matchmaking, a crying baby played indicates no common overlap is present, or a friendly animation is played to indicate otherwise. The users can then choose to share missing songs with each other. The following scripts conceptually show this application.

Main script:

```
<smil xmlns=“http://www.w3.org/2001/SMIL20/Language”>
...
<body>
  <par
begin=“BT_transfer_started(playlist=“my_Jackie.-
xml”,match_method=“XOR”)”>
    <a href=“match_result.smil” actuate=“onLoad”/>
  </par>
  <img src=“crying_baby.gif” repeatDur=“indefinite”/>
</body>
</smil>
```

Example match_result.smil:

```
<smil xmlns=“http://www.w3.org/2001/SMIL20/Language”>
...
<body>
  <par>
    <img src=“friend.gif” repeatDur=“indefinite”/>
    <text id=“song_dec1” src=“song_dec1.txt” begin=“indefinite”
play_method=“share”/>
    <audio id=“song1” src=“song1.mp3” begin=“song_dec1.end”
play_method=“share”/>
    <text id=“song_dec2” src=“song_dec2.txt” play_method=“share”/>
    <audio id=“song2” src=“song2.mp3” begin=“song_dec2.end”
play_method=“share”/>
    <text id=“song_dec3” src=“song_dec3.txt” begin=“song2.end”
play_method=“share”/>
    <audio id=“song3” src=“song3.mp3” begin=“song_dec3.end”
play_method=“share”/>
    ...
  </par>
  </body>
</smil>
```

Here, when the connection between the two devices is initiated using a protocol such as Bluetooth, the pair's playlist is passed through along with the connection event. Then the matching of the two playlists is performed according to match_method which designates how to do event parameter matching. “XOR” here means it is noted only when one item in the playlist is different. Correspondingly, a playable item for it is created in the match_result.smil (an example intermediate file). For example, here song2 is different, so its text description and music data would be put there. When the <par> element in the main script is active, which means at least one item is different, the child <a> element is active (which means the link is followed) to play the match_result.smil. This file then shows the “friend” animated gif along with sharing of the missing song descriptions and music data. Note that elements with the attribute “begin=“indefinite”” would not start (i.e., are marked out).

Another example of an application that can be created according to the exemplary embodiments of this invention is a friend introduction system. Suppose user A and user B are within Bluetooth range (e.g., they have a meeting together). User B matches their phonebook to show user A the potential friends he can make (the missing items in user A's phonebook). When someone is found within this same piconet, a short message is sent to him saying “Nice to meet you, I know you from user B and would like to make friends with you”.

The functionality described above can be extended to servers which can run such scripts when communicating with mobile devices. This creates on-line services in a similar manner. The online multimedia health care system described above is an extension of the blood pressure alert system described earlier. Compared to the simple solutions, the server helps in at least two aspects. First, the SMIL based multimedia effect is improving communication and thus performs better than a simple short message or mobile device call. Secondly, the server as the mediator prolongs the communication by automatically connecting people (e.g., by responding to events from them). Creating applications according to various embodiments of this invention means the service can also be customized by scripts. For example, a doctor can customize his service scripts for each patient.

Particularly for messaging functions, the current solutions of content sharing are applicable even though the script itself is small and easy to transfer, since it is generally preferable to include the content with the script. For example, considering the content might be large, medium or small, three exemplary techniques are described. First, short range transfer, such as a Bluetooth connection or PC connection, can be used to transfer the whole package with the script and the content. Secondly, some content can be stored online with links embedded in scripts so that only the content needed is downloaded when the scripts are activated for the first time. MMS can still help transfer the scripts along with smaller content (e.g., over a mobile network). Thirdly, the whole package could be stored in a memory card, such as a Multi Media Card (MMC) or Secure Digital (SD) card, so that users can buy the content and use it or give it to others as gifts.

As an exemplary performance optimization, to alleviate the event monitor's workload, an auxiliary tool, such as a setting converter, can be designed. For example, the setting converter can transfer special scripts (for example, playing video when receiving a specific caller's incoming call) to some application settings, such as the profile/phonebook setting for the specific caller.

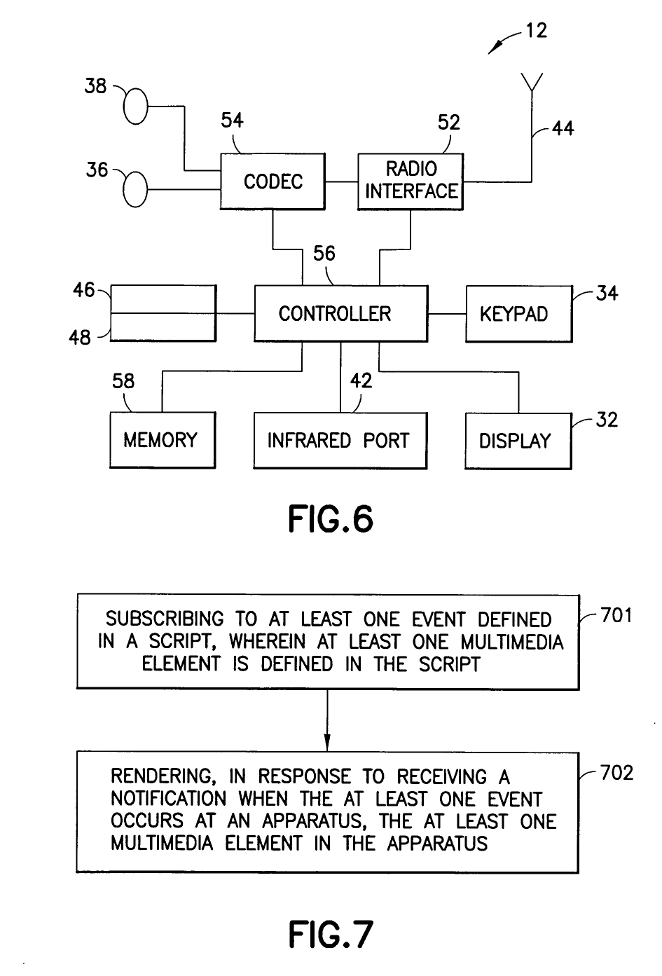

FIGS. 5 and 6 show an exemplary mobile device 12 within which the exemplary embodiments of this invention may be implemented. It should be understood, however, that the exemplary embodiments of this invention are not intended to be limited to one particular type of electronic device and are suitable for use with other mobile or stationary devices. The mobile device 12 of FIGS. 5 and 6 is comprised of various components that may include: a housing 30, a display 32 (e.g., a liquid crystal display), a keypad 34, a microphone 36, an ear-piece 38 (e.g., a speaker), a battery 40, an infrared port 42, an antenna 44, a smart card 46, a card reader 48, a radio interface circuit 52, a codec circuit 54, a controller 56 and a memory 58. These individual circuits and elements may all be of a type well known in the art. In some exemplary embodiments, the high-speed serial interface discussed above can be used to implement the communication between any two components in FIG. 6, for example, between the controller 56 and display 32, between the controller 56 and codec 54 or between the codec 54 and the radio interface 52.

As a non-limiting example, the radio interface 52 may include one or more transceivers (having a transmitter and a receiver) and further may enable the mobile device 12 to communicate with one or more other electronic devices. In other exemplary embodiments, the infrared port 42 may be utilized for communication with one or more other electronic devices. The controller 56 may be of any type suitable to the local technical environment, and may include one or more of processors, data processors, general purpose computers, special purpose computers, microprocessors, digital signal processors (DSPs) and processors based on a multi-core processor architecture, as non-limiting examples. The memory 58 may be of any type suitable to the local technical environment and may be implemented using any suitable data storage technology, such as semiconductor-based memory devices, magnetic memory devices and systems, optical memory devices and systems, fixed memory and removable memory, as non-limiting examples. In other exemplary embodiments, one or more chips, chipsets, circuits, integrated circuits and/or application specific integrated circuits (ASICs) may be utilized such that the mobile device 12 is operable in accordance with the exemplary embodiments of the invention.

In some exemplary embodiments, the mobile device 12 is configured to communicate with one or more network components of a wireless network. As non-limiting examples, the network components may comprise base stations or relay nodes. In such a manner, the event that triggers implementation of the exemplary embodiments of the invention by the mobile device 12 may comprise such network events as receiving a message or transmitting a message, as non-limiting examples. Furthermore, in some exemplary embodiments the network connection may be utilized for other purposes, such as to obtain location information for the mobile device 12, for example.

The exemplary embodiments of this invention may be implemented by computer software executable by the controller 56 of the mobile device 12, or by hardware, or by a combination of software and hardware. In general, the various exemplary embodiments of the mobile device 12 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

In some exemplary embodiments, the memory 58 stores a program (not shown). The program includes program instructions that, when executed by the controller, enable the mobile device 12 to operate in accordance with the exemplary embodiments of this invention, as discussed herein. While illustrated in FIGS. 5 and 6 using a mobile device 12, the exemplary embodiments of the invention may also be utilized in conjunction with a fixed electronic device, such as a desktop computer, for example.

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

(1) In one non-limiting exemplary embodiment, and as shown in FIG. 7, a method comprising: subscribing to at least one event defined in a script, wherein at least one multimedia element is defined in the script (701); and rendering, in response to receiving a notification when the at least one event occurs at an apparatus, the at least one multimedia element in the apparatus (702).

A method as above, further comprising: editing the script based on a pre-defined template; and saving the edited script on the apparatus. A method as in any above, further comprising: sending the script to another apparatus. A method as in any above, wherein the script is sent via e-mail. A method as in any above, wherein the script is sent via a messaging service. A method as in any above, further comprising: receiving the script from another apparatus. A method as in any above, further comprising: activating the received script automatically based on a pre-defined criteria. A method as in any above, further comprising: activating the received script based on a user input at the apparatus.

A method as in any above, wherein the at least one event comprises reception of a short message and the at least one multimedia element is selected from a group comprising: an image, a video clip and an audio clip. A method as in any above, wherein the at least one event comprises reaching a predefined time and the at least one multimedia element is selected from a group comprising: an image, a video clip and an audio clip. A method as in any above, wherein the at least one event comprises an inactive time of the apparatus exceeding a predefined value and the at least one multimedia element is selected from a group comprising: an image, a video clip and an audio clip.

A method as in any above, wherein the at least one event comprises a difference between a measured value and a predefined value exceeding a predefined threshold value and the at least one multimedia element is selected from a group comprising: an image, a video clip and an audio clip. A method as in any above, wherein the measured value is a blood pressure of a user of the apparatus. A method as in any above, wherein the measured value is a blood sugar of a user of the apparatus.

A method as in any above, wherein the at least one event comprises a distance between a location of the apparatus and a predefined location exceeding a predefined threshold and the at least one multimedia element is selected from a group comprising: an image, a video clip and an audio clip. A method as in any above, wherein the location of the apparatus is obtained from a global positioning device. A method as in any above, wherein the script comprises a synchronized multimedia integration language script and the apparatus comprises a mobile terminal. A method as in any above, wherein the method is implemented by a computer program. A method as in any above, wherein the method is implemented by a computer program stored on a computer-readable medium and executable by a processor of an apparatus. A method as in any above, wherein the apparatus comprises a mobile terminal.

(2) In another exemplary embodiment, a program storage device readable by a machine, tangibly embodying a program of instructions executable by the machine for performing operations, said operations comprising: subscribing to at least one event defined in a script, wherein at least one multimedia element is defined in the script; and rendering, in response to receiving a notification when the at least one event occurs at an apparatus, the at least one multimedia element in the apparatus.

A program storage device as above, said operations further comprising: editing the script based on a pre-defined template; and saving the edited script on the apparatus. A program storage device as in any above, said operations further comprising: sending the script to another apparatus. A program storage device as in any above, wherein the script is sent via e-mail. A program storage device as in any above, wherein the script is sent via a messaging service. A program storage device as in any above, said operations.further comprising: receiving the script from another apparatus. A program storage device as in any above, said operations further comprising: activating the received script automatically based on a pre-defined criteria. A program storage device as in any above, said operations further comprising: activating the received script based on a user input at the apparatus.

A program storage device as in any above, wherein the at least one event comprises reception of a short message and the at least one multimedia element is selected from a group comprising: an image, a video clip and an audio clip. A program storage device as in any above, wherein the at least one event comprises reaching a predefined time and the at least one multimedia element is selected from a group comprising: an image, a video clip and an audio clip. A program storage device as in any above, wherein the at least one event comprises an inactive time of the apparatus exceeding a predefined value and the at least one multimedia element is selected from a group comprising: an image, a video clip and an audio clip.

A program storage device as in any above, wherein the at least one event comprises a difference between a measured value and a predefined value exceeding a predefined threshold value and the at least one multimedia element is selected from a group comprising: an image, a video clip and an audio clip. A program storage device as in any above, wherein the measured value is a blood pressure of a user of the apparatus. A program storage device as in any above, wherein the measured value is a blood sugar of a user of the apparatus.

A program storage device as in any above, wherein the at least one event comprises a distance between a location of the apparatus and a predefined location exceeding a predefined threshold and the at least one multimedia element is selected from a group comprising: an image, a video clip and an audio clip. A program storage device as in any above, wherein the location of the apparatus is obtained from a global positioning device. A program storage device as in any above, wherein the script comprises a synchronized multimedia integration language script and the apparatus comprises a mobile terminal. A program storage device as in any above, wherein the machine comprises the apparatus. A program storage device as in any above, wherein the apparatus comprises a mobile terminal.

(3) In another exemplary embodiment, an apparatus comprising: at least one user interface component; and a processor configured to subscribe to at least one event defined in a script, wherein at least one multimedia element is defined in the script, wherein the processor is further configured, in response to receiving a notification when the at least one event occurs at the apparatus, to render the at least one multimedia element in the apparatus using the at least one user interface component.

An apparatus as above, wherein the processor is further configured to enable a user to edit the script (e.g., via at least one other user interface component) based on a pre-defined template and to save the edited script. on the apparatus (e.g., in or on a memory). An apparatus as in any above, further comprising: a transmitter configured to send the script to another apparatus. An apparatus as in any above, wherein the script is sent via e-mail. An apparatus as in any above, wherein the script is sent via a messaging service. An apparatus as in any above, further comprising: a receiver configured to receive the script from another apparatus. An apparatus as in any above, wherein the processor is further configured to activate the received script automatically based on a pre-defined criteria. An apparatus as in any above, wherein the processor is further configured to activate the received script based on a user input at the apparatus.

An apparatus as in any above, wherein the at least one event comprises reception of a short message and the at least one multimedia element is selected from a group comprising: an image, a video clip and an audio clip. An apparatus as in any above, wherein the at least one event comprises reaching a predefined time and the at least one multimedia element is selected from a group comprising: an image, a video clip and an audio clip. An apparatus as in any above, wherein the at least one event comprises an inactive time of the apparatus exceeding a predefined value and the at least one multimedia element is selected from a group comprising: an image, a video clip and an audio clip.

An apparatus as in any above, wherein the at least one event comprises a difference between a measured value and a predefined value exceeding a predefined threshold value and the at least one multimedia element is selected from a group comprising: an image, a video clip and an audio clip. An apparatus as in any above, wherein the measured value is a blood pressure of a user of the apparatus. An apparatus as in any above, wherein the measured value is a blood sugar of a user of the apparatus.

An apparatus as in any above, wherein the at least one event comprises a distance between a location of the apparatus and a predefined location exceeding a predefined threshold and the at least one multimedia element is selected from a group comprising: an image, a video clip and an audio clip. An apparatus as in any above, further comprising: a location-sensing component (e.g., a global positioning system receiver). An apparatus as in any above, wherein the location of the apparatus is obtained from a global positioning device or global positioning system. An apparatus as in any above, wherein the script comprises a synchronized multimedia integration language script and the apparatus comprises a mobile terminal. An apparatus as in any above, wherein the apparatus comprises a mobile terminal. An apparatus as in any above, wherein the apparatus comprises a mobile station, a mobile device, or a user equipment. An apparatus as in any above, further comprising: a transceiver. An apparatus as in any above, further comprising a memory. An apparatus as in any above, wherein the at least one user interface component comprises a speaker or a display. An apparatus as in any above, wherein the at least one user interface component comprises a tactile user interface component.

(4) In another exemplary embodiment, an apparatus comprising: means for subscribing to at least one event defined in a script, wherein at least one multimedia element is defined in the script; and means for rendering, in response to receiving a notification when the at least one event occurs at an apparatus, the at least one multimedia element in the apparatus.

An apparatus as above, further comprising: means for enabling a user to edit the script (e.g., via at least one other user interface component) based on a pre-defined template and to save the edited script on the apparatus (e.g., in or on a memory). An apparatus as in the previous, wherein the means for enabling comprises at least one user interface component. An apparatus as in any above, further comprising: means for sending the script to another apparatus. An apparatus as in the previous, wherein the means for sending comprises a transmitter or a transceiver. An apparatus as in any above, wherein the script is sent via e-mail. An apparatus as in any above, wherein the script is sent via a messaging service. An apparatus as in any above, further comprising: means for receiving the script from another apparatus. An apparatus as in the previous, wherein the means for receiving comprises a receiver or a transceiver. An apparatus as in any above, further comprising: means for activating the received script automatically based on a pre-defined criteria. An apparatus as in any above, further comprising: means for activating the received script based on a user input at the apparatus. An apparatus as in any above, wherein the means for activating comprises at least one processor.

An apparatus as in any above, wherein the at least one event comprises reception of a short message and the at least one multimedia element is selected from a group comprising: an image, a video clip and an audio clip. An apparatus as in any above, wherein the at least one event comprises reaching a predefined time and the at least one multimedia element is selected from a group comprising: an image, a video clip and an audio clip. An apparatus as in any above, wherein the at least one event comprises an inactive time of the apparatus exceeding a predefined value and the at least one multimedia element is selected from a group comprising: an image, a video clip and an audio clip.

An apparatus as in any above, wherein the at least one event comprises a difference between a measured value and a predefined value exceeding a predefined threshold value and the at least one multimedia element is selected from a group comprising: an image, a video clip and an audio clip. An apparatus as in any above, wherein the measured value is a blood pressure of a user of the apparatus. An apparatus as in any above, wherein the measured value is a blood sugar of a user of the apparatus.

An apparatus as in any above, wherein the at least one event comprises a distance between a location of the apparatus and a predefined location exceeding a predefined threshold and the at least one multimedia element is selected from a group comprising: an image, a video clip and an audio clip. An apparatus as in any above, further comprising: means for determining a location of the apparatus. An apparatus as in the previous, wherein the means for determining comprises a global positioning system receiver. An apparatus as in any above, wherein the location of the apparatus is obtained from a global positioning device or global positioning system. An apparatus as in any above, wherein the script comprises a synchronized multimedia integration language script and the apparatus comprises a mobile terminal. An apparatus as in any above, wherein the apparatus comprises a mobile terminal. An apparatus as in any above, wherein the apparatus comprises a mobile station, a mobile device, or a user equipment. An apparatus as in any above, further comprising: means for transmitting; and means for receiving. An apparatus as in the previous, wherein the means for transmitting and the means for receiving comprise a transceiver. An apparatus as in any above, further comprising: means for storing. An apparatus as in the previous, wherein the means for storing comprises a memory. An apparatus as in any above, wherein the means for subscribing comprises at least one processor and the means for rendering comprises at least one user interface component. An apparatus as in any above, wherein the at least one user interface component comprises a speaker or a display. An apparatus as in any above, wherein the at least one user interface component comprises a tactile user interface component.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

While the exemplary embodiments have been described above in the context of wireless communication systems, it should be appreciated that the exemplary embodiments ofthis invention are not limited for use with only this one particular type of communication system, and that they may be used to advantage in other communication systems, including wired communication systems.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description of exemplary embodiments of this invention have been presented for purposes of illustration and description. It is not intended to be exhaustive or to limit the exemplary embodiments of this invention to the precise forms disclosed. Various modifications and variations may become apparent to those skilled in the relevant arts in light of the above teachings, when read in conjunction with the accompanying drawings and the appended claims. As a non-limiting example, while described above with respect to multimedia elements and alerts, the exemplary embodiments of the invention are not limited thereto and may also be utilized in conjunction with other types of user notifications and alerts, such as vibrational notifications or other tactile notification or alerts, for example. However, all such and similar modifications of the teachings of this invention will still fall within the scope of the non-limiting and exemplary embodiments of this invention. The exemplary embodiments were described in order to explain the principles of the exemplary embodiments of this invention and to enable one skilled in the art to utilize the exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
subscribing to at least one event defined in a script, wherein at least one multimedia element is defined in the script; and
rendering, in response to receiving a notification when the at least one event occurs at an apparatus, the at least one multimedia element in the apparatus.

2. The method of claim 1, further comprising: editing the script based on a pre-defined template; and saving the edited script on the apparatus.

3. The method of claim 1, further comprising: sending the script to another apparatus.

4. The method of claim 3, wherein the script is sent via e-mail or a messaging service.

5. The method of claim 1, further comprising: receiving the script from another apparatus.

6. The method of claim 6, further comprising: activating the received script automatically based on a pre-defined criteria or a user input at the apparatus.

7. The method of claim 1, wherein the at least one multimedia element is selected from a group comprising: an image, a video clip and an audio clip, wherein the at least one event comprises at least one of reception of a short message, reaching a predefined time, or an inactive time of the apparatus exceeding a predefined value.

8. The method of claim 1, wherein the at least one event comprises a difference between a measured value and a predefined value exceeding a predefined threshold value and the at least one multimedia element is selected from a group comprising: an image, a video clip and an audio clip.

9. The method of claim 12, wherein the measured value is a blood pressure of a user of the apparatus or a blood sugar of a user of the apparatus.

10. The method of claim 1, wherein the at least one event comprises a distance between a location of the apparatus and a predefined location exceeding a predefined threshold and the at least one multimedia element is selected from a group comprising: an image, a video clip and an audio clip.

11. The method of claim 1, wherein the script comprises a synchronized multimedia integration language script and the apparatus comprises a mobile terminal.

12. An apparatus, comprising:
at least one user interface component; and
a processor configured to subscribe to at least one event defined in a script, wherein at least one multimedia element is defined in the script, wherein the processor is further configured, in response to receiving a notification when the at least one event occurs at the apparatus, to render the at least one multimedia element in the apparatus using the at least one user interface component.

13. The apparatus of claim 12, wherein the processor is further configured to enable a user to edit the script based on a pre-defined template and to save the edited script on the apparatus.

14. The apparatus of claim 12, further comprising: a transmitter configured to send the script to another apparatus.

15. The apparatus of claim 12, further comprising: a receiver configured to receive the script from another apparatus.

16. The apparatus of claim 15, wherein the processor is further configured to activate the received script automatically based on a pre-defined criteria or a user input at the apparatus.

17. The apparatus of claim 12, wherein the at least one multimedia element is selected from a group comprising: an image, a video clip and an audio clip, wherein the at least one event comprises at least one of reception of a short message by a receiver of the apparatus, reaching a predefined time, or an inactive time of the apparatus exceeding a predefined value.

18. The apparatus of claim 12, wherein the at least one event comprises a difference between a measured value and a predefined value exceeding a predefined threshold value and the at least one multimedia element is selected from a group comprising: an image, a video clip and an audio clip.

19. The apparatus of claim 12, further comprising: a location-sensing component, wherein the at least one event comprises a distance between a location of the apparatus and a predefined location exceeding a predefined threshold and the at least one multimedia element is selected from a group comprising: an image, a video clip and an audio clip.

20. The apparatus of claim 12, wherein the script comprises a synchronized multimedia integration language script and the apparatus comprises a mobile terminal.

21. The apparatus of claim 12, wherein the at least one user interface component comprises a speaker or a display.

22. A program storage device readable by an apparatus, tangibly embodying a program of instructions executable by the apparatus for performing operations, said operations comprising:
subscribing to at least one event defined in a script, wherein at least one multimedia element is defined in the script; and
rendering, in response to receiving a notification when the at least one event occurs at the apparatus, the at least one multimedia element in the apparatus.

23. The program storage device of claim 22, said operations further comprising: editing the script based on a pre-defined template; and saving the edited script on the apparatus.

24. The program storage device of claim 22, said operations further comprising: sending the script to another apparatus.

25. The program storage device of claim 24, wherein the script is sent via e-mail or a messaging service.

26. The program storage device of claim 22, said operations further comprising: receiving the script from another apparatus.

27. The program storage device of claim 22, said operations further comprising: activating the received script automatically based on a pre-defined criteria or a user input at the apparatus.

28. The program storage device of claim 22, wherein the at least one multimedia element is selected from a group comprising: an image, a video clip and an audio clip, wherein the at least one event comprises at least one of reception of a short message, reaching a predefined time, or an inactive time of the apparatus exceeding a predefined value.

29. The program storage device of claim 22, wherein the at least one event comprises a difference between a measured value and a predefined value exceeding a predefined threshold value and the at least one multimedia element is selected from a group comprising: an image, a video clip and an audio clip.

30. The program storage device of claim 29, wherein the measured value is a blood pressure of a user of the apparatus or a blood sugar of a user of the apparatus.

31. The program storage device of claim 22, wherein the at least one event comprises a distance between a location of the apparatus and a predefined location exceeding a predefined threshold and the at least one multimedia element is selected from a group comprising: an image, a video clip and an audio clip.

32. The program storage device of claim 22, wherein the script comprises a synchronized multimedia integration language script and the apparatus comprises a mobile terminal.

33. An apparatus comprising:
means for subscribing to at least one event defined in a script, wherein at least one multimedia element is defined in the script; and
means for rendering, in response to receiving a notification when the at least one event occurs at an apparatus, the at least one multimedia element in the apparatus.

34. The apparatus of claim 33, wherein the at least one multimedia element is selected from a group comprising: an image, a video clip and an audio clip, wherein the at least one event comprises at least one of reception of a short message, reaching a predefined time, an inactive time of the apparatus exceeding a predefined value, or a difference between a measured value and a predefined value exceeding a predefined threshold value.

35. The apparatus of claim 33, wherein the means for subscribing comprises at least one processor and the means for rendering comprises at least one user interface component.
